(19) United States
(12) Patent Application Publication
(10) Pub. No.: US 2011/0123034 A1
(43) Pub. Date: May 26, 2011

(54) AUDIO TEST DEVICE AND AUDIO TEST METHOD THEREOF

(75) Inventor: YI-CHING LOU, Tu-Cheng (TW)

(73) Assignee: HON HAI PRECISION INDUSTRY CO., LTD., Tu-Cheng (TW)

(21) Appl. No.: 12/846,848

(22) Filed: Jul. 30, 2010

(30) Foreign Application Priority Data
Nov. 25, 2009 (CN) 200910310391.6

(51) Int. Cl. H04R 29/00

(52) U.S. Cl. 381/58

(57) ABSTRACT

A method for audio test of an audio test device is provided. The audio test device includes audio ports, decoders, a storage unit, and an encoder. Each of the decoders includes an identification corresponding to one of the audio ports. The storage unit stores audio files. The method includes displaying a test interface, which includes a plurality of recording the audio ports and a plurality of recording preset test items being corresponding to the audio files; obtain the IDs of the decoders and the audio files; controlling the encoders to encode the audio files and to embed the corresponding ID, and identifying the IDs of the encoded audio files and transmits the encoded audio files to the corresponding decoders according to the identified IDs. A related audio test device is also provided.

### BACKGROUND

1. Technical Field

The present disclosure relates to test devices and, particularly, to an audio test device for testing audio quality of different audio devices and an audio test method thereof.

2. Description of Related Art

Manufacturers need to use an audio test device to test audio quality of audio devices such as earphones. A conventional audio test device usually includes a plurality of audio ports, so that a plurality of audio devices can be tested simultaneously. The conventional audio test device further includes a plurality of decoders each of which corresponds to one of the audio ports. An audio file decoded by one of the decoders is transmitted to the corresponding audio port to test an audio device connected to that audio port. When the audio test device is employed to test a plurality of audio devices simultaneously, the audio test device may assign a wrong audio file to a decoder, thus the audio device connected to the audio port corresponding to the decoder may not be accurately tested.

### BRIEF DESCRIPTION OF THE DRAWINGS

The components of the drawings are not necessarily drawn to scale, the emphasis instead being placed upon clearly illustrating the principles of an audio test device and an audio test method thereof. Moreover, in the drawings, like reference numerals designate corresponding parts throughout several views.

FIG. 1 is a block diagram of an audio test device in accordance with an exemplary embodiment.

FIG. 2 is a schematic view showing a test interface of the audio test device of FIG. 1.

FIG. 3 is a schematic diagram showing an encoded audio file including an identification (ID) of a decoder of the audio test device of FIG. 1.

FIG. 4 is a flowchart of an audio test method in accordance with an exemplary embodiment.

### DETAILED DESCRIPTION

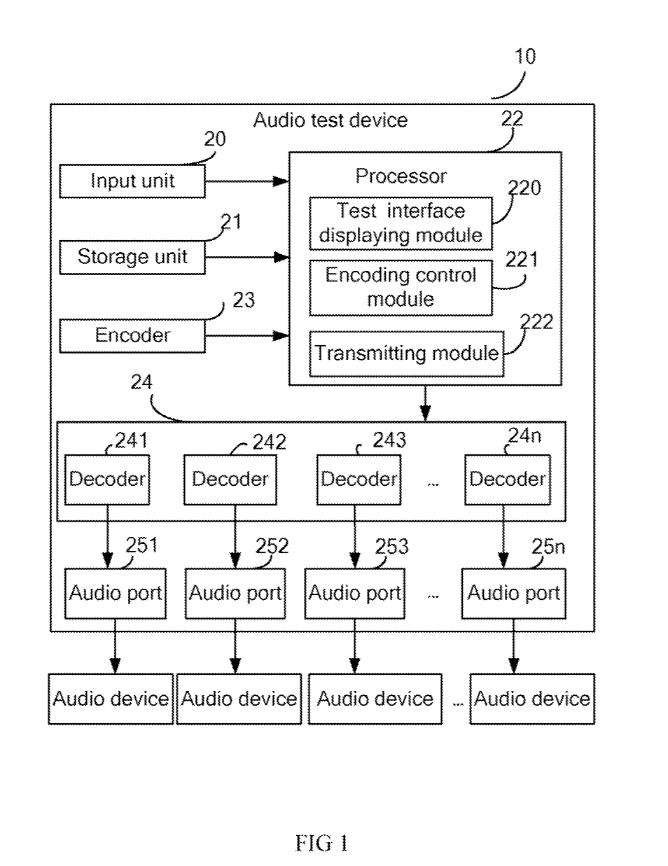

Referring to FIG. 1, an audio test device 10 in accordance with an exemplary embodiment is provided. The audio test device 10 is capable of testing audio quality of different audio devices simultaneously.

The audio test device 10 includes an input unit 20, a storage unit 21, a processor 22, an encoder 23, a number of decoders 241, 242, . . . , and 24n, and a corresponding number of audio ports 251, 252, 253, . . . , and 25n. Each of the decoders 241-24n includes an ID for identifying itself, and corresponds to one of the audio ports 251-25n. Each of the audio ports 251-25n can be connected to an audio device. The audio device may be an earphone, a sound box, or the like.

The storage unit 21 stores audio files and the IDs of the decoders. Each of the audio files corresponds to a test item. In this embodiment, the test item may be a treble test, a mediant test, a bass test, or the like.

The processor 22 includes a test interface displaying module 220, an encoding control module 221 and a transmitting module 222.

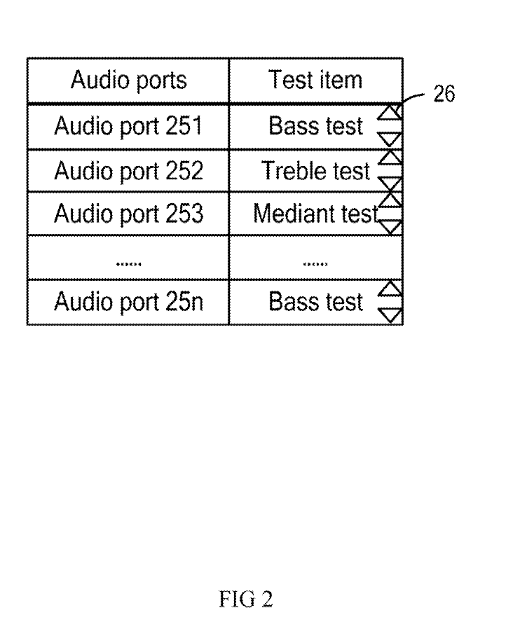

The test interface displaying module 220 is configured to display a test interface including a column of recording audio ports and a column of recording test items (see FIG. 2). Each of the audio ports corresponds to one test item. As shown in FIG. 2, an operator can select one test item for an audio port by using the input unit 20 to click direction icons 26 to change the order of the test item. In the embodiment, the direction icons 26 include an up arrow icon and a down arrow icon. When the user clicks a down arrow icon, a next test item becomes visible and takes place of a current visible test item. When the user clicks an up arrow icon, an immediate preceding test item becomes visible and takes place of the current visible test item. The current visible test item is accordingly hid. In an alterative embodiment, the direction icons 26 are up arrow icons and an immediate preceding test item takes place of the current visible test item when an up arrow icon is clicked, the last one in a test item lists immediately precedes the first one listed in the test item lists. In still an alternative embodiment, the direction icons 26 are down arrow icons and a next test item takes place of the current visible test item when a down arrow icon is clicked, the first one in the test lists immediately precedes the last one listed in the test item lists.

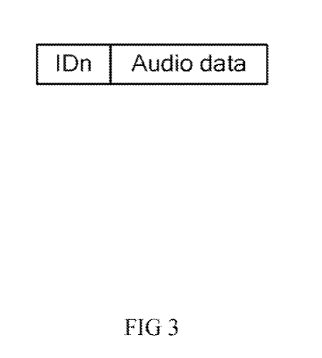

The encoding control module 221 is configured to obtain the IDs of the decoders corresponding to the selected audio ports and obtain audio files corresponding to the selected test items associated with the selected audio ports from the storage unit 21, and transmit the obtained IDs and the obtained audio files to the encoder 23. The encoding control module 221 is further configured to control the encoder 23 to encode the obtained audio files to embed the corresponding IDs in the corresponding obtained audio files (see FIG. 3).

The transmitting module 222 is configured to identify the ID embedded in the encoded audio files and transmit the encoded audio files to the corresponding decoders according to the identified IDs. With such configuration, the transmitting module 222 is able to transmit the proper encoded audio files to a decoder. Therefore, the audio quality of each audio device can be accurately tested.

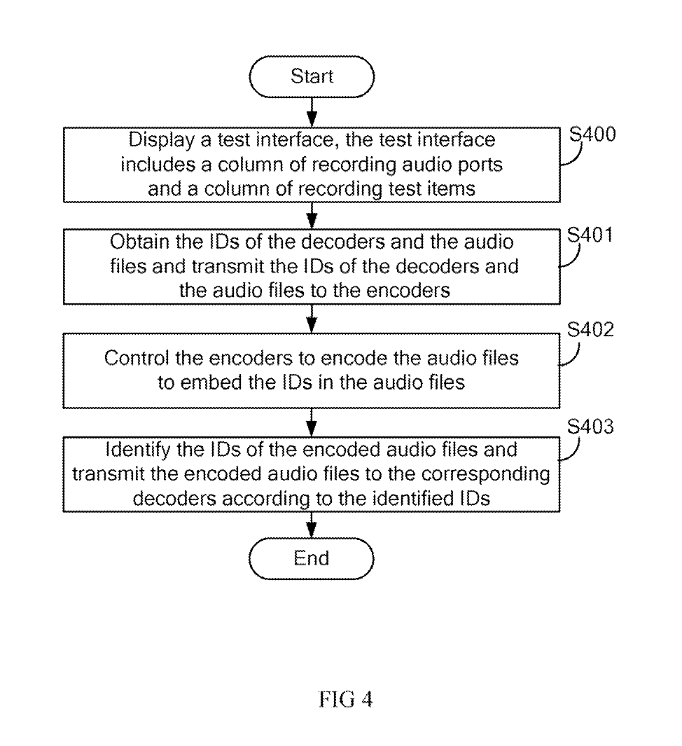

Referring to FIG. 4, a flowchart of a method for audio test is provided.

In step S400, the test interface displaying module 220 displays a test interface. The test interface includes a column of recording audio ports and a column of recording test items. Each of the audio ports corresponds to one of the test items.

In step S401, the encoding control module 221 obtains the IDs of the decoders 24 corresponding to the selected audio ports and obtains audio files corresponding to the selected test items associated with the selected audio ports from the storage unit 21, and transmits the obtained IDs and the obtained audio files to the encoder 23.

In step S402, the encoding control module 221 controls the encoder 23 to encode each of the obtained audio files to embed the corresponding IDs in the corresponding obtained audio files.

In step S403, the transmitting module 222 identifies the ID embedded in the encoded audio files and transmits the encoded audio files to the corresponding decoders according to the identified IDs.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An audio test device, comprising:
a plurality of audio ports;
a plurality of decoders, each of the decoders comprising an identification (ID) for identifying itself and corresponds to one of the plurality of audio ports;
a storage unit to store audio files;
an encoder; and
a processor comprising:
a test interface displaying module configured to display a test interface comprising a plurality of recording audio ports and a plurality of recording test items being corresponding to the plurality of audio ports, the test items being corresponding to one of the plurality of audio files;
an encoding control module configured to obtain the IDs of the decoders corresponding to the audio ports and obtain audio files corresponding to the test items from the storage unit and transmit the IDs and the audio files to the encoder, and control the encoder to encode the audio files to embed the corresponding IDs in the corresponding audio files; and
a transmitting module configured to identify the IDs embedded in the encoded audio files and transmit the encoded audio file to the corresponding decoders according to the identified IDs.

2. The audio test device as described in claim 1 further comprising an input unit configured for an operator to select the test items for the audio ports through the test interface.

3. The audio test device as described in claim 2, wherein the test items comprise treble tests, mediant tests, and bass tests.

4. A method for audio test of an audio test device, the audio test device comprising a plurality of audio ports, a plurality of decoders, a storage unit, and an encoder, each of the decoders comprising an identification (ID) for identifying itself and corresponding to one of the plurality of audio ports, the storage unit configured to store audio files, the method comprising:
displaying a test interface for users to preset test items for the audio ports, the test interface comprising a plurality of recording the audio ports and a plurality of recording the preset test items being corresponding to the plurality of audio ports, the test items being corresponding to the plurality of audio files;
obtaining the IDs of the decoders corresponding to the plurality of audio ports and the audio files corresponding to the plurality of test items;
controlling the encoder to encode the obtained audio files to embed the corresponding IDs in the corresponding audio files; and
identifying the IDs embedded in the encoded audio files and transmitting the encoded audio files to the corresponding decoders according to the identified IDs.

5. The method as described in claim 4, wherein the test items comprise treble tests, mediant tests, and bass tests.
